(19) United States
(12) Patent Application Publication
(10) Pub. No.: US 2023/0219134 A1
(43) Pub. Date: Jul. 13, 2023

(54) SYSTEMS AND METHODS FOR REJUVENATION OF COPPER ALLOY

(71) Applicant: 6K Inc., North Andover, MA (US)

(72) Inventors: Azin Houshmand, Woburn, MA (US); John Meyer, Boxford, MA (US); Makhlouf Redjdal, Melrose, MA (US)

(21) Appl. No.: 18/152,524

(22) Filed: Jan. 10, 2023

Related U.S. Application Data
(60) Provisional application No. 63/298,583, filed on Jan. 11, 2022.

(51) Int. Cl. B22F 1/142; B22F 1/05; B22F 9/22; B22F 1/065

(52) U.S. Cl. CPC B22F 1/142; B22F 1/05; B22F 9/22; B22F 1/065; B22F 2009/001

(57) ABSTRACT

The embodiments disclosed herein are directed to systems and methods for manufacturing recycled copper alloy powder particles from used or deficient copper alloy powder particles. In some embodiments, used copper alloy powder particles comprising near-surface oxygen are introduced into a microwave plasma torch. In some embodiments, the used copper alloy powder particles are heated within the microwave plasma torch to at least partially remove the oxygen and form recycled copper alloy powder particles, without melting the used copper alloy powder particles.

### INCORPORATION BY REFERENCE TO ANY PRIORITY APPLICATIONS

This application claims the priority benefit under 35 U.S.C. § 119(e) of U.S. Provisional Application No. 63/298,583, filed Jan. 11, 2022, the entire disclosure of which is incorporated herein by reference in its entirety. Any and all applications for which a foreign or domestic priority claim is identified in the Application Data Sheet as filed with the present application are hereby incorporated by reference under 37 CFR 1.57.

### BACKGROUND

### Field

The present disclosure is generally directed in some embodiments to producing spheroidal powder products from feedstock materials generated from recycled used and/or high interstitial content powder.

### Description

Additive manufacturing (AM) is an emerging technology that offers significant potential to reduce lead times and cost of fabrication for complex components such as liquid rocket engine combustion chambers. NASA has observed the growing need for AM, specifically laser powder bed fusion (L-PBF), for fabrication of copper-alloys for liquid rocket engine components. While high strength alloys, such as nickel-based superalloys, are readily available, they are not the optimized solution for high performance engine systems without performance impacts through fuel film cooling or reduction in life.

GRCop-42 is a high conductivity, high-strength dispersion strengthened copper-alloy (Cu-alloy) for use in high heat flux applications such as liquid rocket engine combustion devices. GRCop-42 alloy is part of the family of copper-chromium-niobium alloys. GRCop alloys were developed to be utilized in harsh environments specific to regeneratively-cooled combustion chambers and nozzles with good oxidation resistance. Processes for additive manufacturing using GRCop-42 have been developed, specifically laser powder bed fusion (L-PBF). GRCop-42 has several advantages over other copper-chromium-niobium alloys, including higher conductivity, faster build speeds, and a simplified powder supply chain. Initial development has shown that it is possible to produce high density builds with greater strength and a conductivity than GRCop-84.

For powder bed AM, the entire build volume, not just the part volume, must be filled with feedstock powder. For existing large-scale AM machines, approximately 499 kg (1,100 lbs.) of powder is required to fill the entire build volume. This does not consider additional material required for filling the feed piston and powder scraped off the build into the overflow hopper. This can greatly increase the minimum amount of powder required for a build. While pricing is subject to change, the cost of the powder alone easily can be tens of thousands of dollars.

Current processes for producing GRCop powders utilize powder atomization, which may be extremely complex and costly. For example, GRCop powder must be atomized using argon gas atomization and handled carefully to avoid oxygen contamination. These requirements, in addition to the quality requirements for AM, results in a limited supply of acceptable powder. Furthermore, there are currently no methods to recycle GRCop powder from, for example, AM applications.

Thus, novel methods and systems for producing and recycling Cu-powders, such as GRCop powder, are needed.

### SUMMARY

For purposes of this summary, certain aspects, advantages, and novel features of the invention are described herein. It is to be understood that not all such advantages necessarily may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

Some embodiments herein are directed to methods for manufacturing recycled copper alloy powder particles from used copper alloy powder particles, the method comprising: introducing used or deficient copper alloy powder particles into a microwave plasma torch, the used copper alloy powder particles comprising an oxygen content above 600 ppm by weight; and heating the used or deficient copper alloy powder particles within the microwave plasma torch to form recycled copper alloy powder particles, the recycled copper alloy powder particles comprising a reduced oxygen content relative to the used or deficient copper alloy.

In some embodiments, the recycled copper alloy powder has an oxygen content at or below 600 ppm by weight. In some embodiments, the used or deficient copper alloy powder particles and the recycled copper alloy powder particles comprise a GRCop (Cu—Cr₂Nb) family alloy. In some embodiments, the GRCop family alloy comprises GRCop-42.

In some embodiments, the methods further comprise collecting the used or deficient copper alloy powder particles from an additive manufacturing process. In some embodiments, the used or deficient powder particles comprise an oxygen content above 1000 ppm by weight. In some embodiments, the recycled copper alloy powder particles comprise an oxygen content at or below 500 ppm by weight.

In some embodiments, the used or deficient copper alloy powder particles are heated to a temperature sufficient to remove oxygen from a surface and/or sub-surface of the used copper alloy powder particles. In some embodiments, the used or deficient copper alloy powder particles are heated to a temperature of less than 1,100° C.

In some embodiments, a reducing gas is introduced into the microwave plasma torch to generate a microwave plasma that heats the used or deficient copper alloy powder particles within the microwave plasma torch. In some embodiments, the reducing gas is hydrogen gas (H₂). In some embodiments, the hydrogen gas is mixed with argon gas. In some embodiments, the hydrogen gas reacts with the used powder particles to reduce the oxygen.

In some embodiments, the recycled copper alloy powder particles have a median sphericity of at least 0.950. In some embodiments, the recycled copper alloy powder particles have a D50 of about 15 μm to about 45 μm. In some embodiments, the recycled copper alloy powder particles comprise a substantially homogenous microstructure.

Some embodiments herein are directed to recycled copper alloy particles manufactured by a process comprising: introducing used or deficient copper alloy powder particles into a microwave plasma torch, the used or deficient copper alloy powder particles comprising an oxygen content above 600 ppm by weight; and heating the used copper alloy powder particles within the microwave plasma torch to form recycled copper alloy powder particles, the recycled copper alloy powder particles comprising a reduced oxygen content relative to the used or deficient copper alloy.

In some embodiments, the recycled copper alloy powder has an oxygen content at or below 600 ppm by weight. In some embodiments, the recycled copper alloy powder particles have a median sphericity of at least 0.950. In some embodiments, the recycled copper alloy powder particles have a D50 of about 15 μm to about 45 μm. In some embodiments, the recycled copper alloy powder particles comprise a substantially homogenous microstructure.

In some embodiments, the used or deficient copper alloy powder particles and the recycled copper alloy powder particles comprise a GRCop family alloy. In some embodiments, the GRCop (Cu—Cr₂Nb) family alloy comprises GRCop-42.

### BRIEF DESCRIPTION OF THE DRAWINGS

The drawings are provided to illustrate example embodiments and are not intended to limit the scope of the disclosure. A better understanding of the systems and methods described herein will be appreciated upon reference to the following description in conjunction with the accompanying drawings, wherein:

FIG. 1 illustrates an exemplary microwave plasma torch that can be used in the production of Cu-alloy materials, according to embodiments of the present disclosure.

FIGS. 2A-B illustrates an exemplary microwave plasma torch that can be used in the production of Cu-alloy materials, according to embodiments of the present disclosure.

FIG. 3 illustrates a table comparing properties of an example used powder and a recycled Cu-alloy powder processed according to some embodiments described herein.

FIG. 4 illustrates a microscopic image comparing example used particles and a recycled Cu-alloy powder processed according to some embodiments described herein.

FIG. 5 illustrates cross-sectional back-scattered electron detector (BSE) images comparing example used particles and a recycled Cu-alloy powder processed according to some embodiments described herein.

FIG. 6 illustrates an example x-ray powder diffraction (XRD) plot comparing example used particles and a recycled Cu-alloy powder processed according to some embodiments described herein.

### DETAILED DESCRIPTION

Although certain preferred embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present technology.

Some embodiments herein are directed to recycling used Cu-alloy powders, including Cu-alloys in the GRCop family, and particularly, GRCop-42. GRCop is a preferred material family for use in rocket engine combustion chamber liners due to oxidation and blanching resistance with thermal and oxidation-reduction cycling, high use temperatures to above approximately 800° C. for sustained durations, material strength at high use temperatures, an established powder supply chain, and a mature AM process. The Cr₂Nb dispersoids have extreme temperature stability up until 800° C., making them exceptional high temperature strengtheners (above this temperature dispersoids begin to coarsen).

High temperature stability makes production of GRCop materials difficult, as the stability prevents dissolution into solid-state copper, making the alloy unable to be solution hardened. Instead, the dispersoids form exclusively during the liquid to solid transformation, requiring rapid cooling of the molten alloy to retain a small dispersoid size. Slow cooling of the alloy through liquid-metal processes such as casting results in over-sized dispersoids (˜1 cm diameter compared to the desired 1-5 μm), resulting in poor strength and conductivity of the bulk material. Thus, powder atomization of the molten alloy is used to rapidly cool individual droplets, resulting in a powder filled with fine Cr₂Nb dispersoids. For operations that require solid material, GRCop powder can be consolidated through direct extrusion or hot isostatic pressing of bulk powder, resulting in a fully dense solid form that can then be machined and worked as any copper alloy. Otherwise, for powder bed applications, the consolidation can be avoided.

Although several GRCop-alloy variants exist, GRCop-42 (Cu—4 at. % Cr—2 at. % Nb) in particular shows improvement in conductivity over other GRCop-alloys, limited reduction in strength compared to GRCop-84, and exhibits simplified powder atomization over GRCop-84.

GRCop-42 trades lower mechanical properties such as strength for significantly higher thermal conductivity. GRCop-42 achieves 85% of the International Annealed Copper Standard (IACS) versus 75% IACS for GRCop-84 at room temperature. However, GRCop-42 has greatly improved thermal conductivity compared GRCop-84 and competing alloys, while having the same strengthening mechanism as GRCop-84, and nearly identical strength up to about 800° C., making it significantly higher than current launch vehicle engine liners.

In general, the two most important properties for selecting an alloy for a combustion chamber liner are thermal conductivity and low cycle fatigue (LCF) resistance. High thermal conductivity is needed to minimize both the hot wall temperature and thermal gradient through the liner wall. LCF occurs during repeated hot firings of the engine during qualification and flight. Depending upon the engine type and usage, anywhere from tens to hundreds of cycles may be accumulated over the life of an engine. Typically, thermal expansion of the constrained liner causes a deformation of 1% or more. This can result in a rapid degradation of the liner and ultimately failure. Based on the development work with extruded GRCop-42, it was determined it could meet several requirements, including high thermal conductivity, excellent creep resistance, long low-cycle fatigue life, and good strength at elevated temperatures. As such, AM processes have been and continue to be developed to build GRCop-42 parts for rocket engine combustion chamber liners.

Currently, there is no commercially available method for post-processing used GRCop materials or other low-oxygen powders to rejuvenate or recycle the powders, without re-melting of the powders, such that the resulting powder is adequate for reuse in AM applications. Without being limited by theory, it is believed that off-size/used GRCop powder cannot be re-melted/recycled because of intermetallic migration to the particle surface and an unsatisfactory level of oxidation in the used powder.

In the case of GRCop materials, in some embodiments, rejuvenation or recycling comprises reducing/removing oxygen, cleaning the surface, and regenerating the powder particles within alloy specifications. Thus, the embodiments herein enable the rejuvenation of old or used feedstock powder, including used Cu-alloy powder, which does not meet alloy specifications for AM, mainly due to high oxygen content, as a result of oxidation during production, storage, or use. The plasma processing described herein can be applied to powders with high oxygen content to produce powders with lower oxygen content and higher sphericity ideal for additive manufacturing applications. As used herein, “old” or “used” powder may be used interchangeably and may refer to powder that was previously used in an AM process prior to receiving the powder, but also to, for example, powder that had not been used previously, but had been oxidized prior to any use. For instance, “old” or “used” powder may comprise material produced by an atomizer that is out of specification for use by, for example, an AM process. “Deficient” powder may also be used to describe the same materials, including those materials that have high interstitial content, low flowability, or low sphericity due to initial production or storage prior to AM or HIP use.

To be useful in AM applications, rejuvenated or recycled Cu-alloy powder particles should exhibit a spherical shape, which can be achieved through the process of spheroidization. This process involves introducing the particles into a plasma processing apparatus with an inert gas (e.g., Ar) and a reducing (e.g., H₂) plasma. In some embodiments, the plasma processing may comprise a hot environment, whereby the process cleans the surface of the particles and strip oxygen in presence of reducing gas. The temperature may be maintained at a temperature sufficient to clean the surface and/or near-surface bulk, but not high enough to fully re-melt the particles. In some embodiments, the plasma processing process may comprise heating used powder particles to a temperature of less than about 1,100° C., less than about 1,000° C., less than about 900° C., less than about 800° C., less than about 700° C., or less than about 600° C., less than about 500° C., or any value between the aforementioned values.

In some embodiments, H₂ may be used as a reductive gas, reacting with the surface of the metal, which may be covered with a metal oxide. In some embodiments, the H₂ may react with the surface oxide reduce the surface oxide to its native metal. As a result, in some embodiments, oxygen may be removed from the surface and/or near-surface and the resulting processed powder may have a lower oxygen content relative to the used metal powder. During the process, each particle may be re-shaped into a spherical geometry, followed by cooling.

Other spheroidization methods of irregular shape powders include TEKNA's (Sherbrook, Quebec, Canada) spheroidization process using inductively coupled plasma (ICP), where powder is entrained within a gas and injected through a hot plasma environment to melt the powder particles. However, this method suffers from non-uniformity of the plasma, which leads to incomplete spheroidization of feedstock. Furthermore, significant differences exist between the microwave plasma apparatuses described herein and other plasma generation torches, such as induction plasma. For example, microwave plasma is hotter on the interior of the plasma plume, while induction is hotter on the outside of the plumes. In particular, the outer region of an induction plasma can reach about 10,000 K while the inside processing region may only reach about 1,000 K. This large temperature difference leads to processing and feeding problems. Furthermore, induction plasma apparatuses are unable to process materials at a low enough temperature to avoid melting of certain materials, including GRCop alloys, without extinguishing the plasma. Thus, the microwave plasma methods and systems described herein may overcome the problems with existing powder recycling technologies by processing used copper alloys.

The embodiments herein provide a new method to recycle Cu alloys by reducing oxygen without the need to fully melt the particles. In some embodiments, avoiding melting the particles may be critical, as melting results in coarsening and heterogeneity of the microstructure, as low density intermetallic may migrate to the particle surface. In some embodiments, controlling the process to avoid melting allows reduction of the surface oxide to the native metal without altering the composition and microstructure in the core of the particle. Furthermore, the processes described herein avoid volatilization of the various elements that would affect chemistry/phase balance of the resulting powder. Additionally, in some embodiments, the plasma processing may avoid sintering of powder particles and improve sphericity, which results in improved powder flow. Also, the apparent density of the particles may be such that the powder is desirable for use in AM applications, such as laser powder bed fusion applications. According to the embodiments herein, a microwave plasma process may be utilized to recycle/rejuvenate used Cu-alloy powder to improve sphericity, maintain alloy chemistry, limit/phase microstructural changes, and maximize oxygen reduction.

In some embodiments, the recycled/rejuvenated powder may comprise oxygen at less than about 600 wt. ppm, and preferably less than about 500 wt. ppm. In some embodiments, the recycled/rejuvenated powder may comprise oxygen at about 0 wt. ppm to about 600 wt. ppm. For example, the recycled/rejuvenated powder may comprise oxygen at about 0 wt. ppm, less than about 100 wt. ppm, less than about 200 wt. ppm, less than about 300 wt. ppm, less than about 400 wt. ppm, less than about 500 wt. ppm, less than about 600 wt. ppm or any value between the aforementioned values.

Although the embodiments herein are primarily directed to recycling copper alloy powders, and in particular, alloys of the GRCop family, the disclosure herein is not limited to those materials. For example, the methods and systems herein may be applicable to any metal or metal alloy, with particular applicability to oxidized metal or metal alloys. For example, used powders comprising Pure Cu (e.g., C110), Cu—Cr—Nb (e.g., GrCop42, GrCop84), Cu—Cr (e.g., C182/C18200), Cu—Cr—Zr (e.g., C18150), Cu—Be (e.g., Alloy 25/C17200, M25, 165), Cu—Al₂O₃ (e.g., Glidcop) may be recycled/rejuvenated according to the methods described herein.

### Recycling Used Powder

Disclosed herein are embodiments of methods, systems, devices, and assemblies for recycling/reusing/reconditioning used Cu-alloy powders (e.g., out-of-spec powder, waste byproducts of AM processes, etc.), such as from post-processing or yield loss. In particular, embodiments of the disclosure allow for the taking of used Cu-alloy powder and converting it into a feedstock for a microwave plasma process to form a final spheroidized and oxygen-free powders, which is of sufficient quality to be used in different processes, such as additive manufacturing processes, metal injection molding (MIM), or hot isostatic pressing (HIP) processes. Thus, in some embodiments large and/or misshapen particles can be re-spheroidized. Used Cu-alloy powder can be of differing quality and therefore it can be challenging to make use of used Cu-alloy powder as feedstock for an AM process, which requires powder having precise specifications. Used Cu-alloy can be contaminated or an incorrect size, or altogether difficult or impossible to process.

In some embodiments, the used Cu-alloy powders may be pre-processed before they are introduced into the plasma process. For example, the powders may be sieved to remove large agglomerations and selected the desired size to be processed in the plasma. In some embodiments, the powders may be cleaned with water, surfactant, detergent, solvent, or any other chemical such as acids to remove contamination. In some embodiments, the powders may be magnetically cleaned if they are contaminated with any magnetic material. In some embodiments, the powder can be pre-treated to de-oxidize the powder. In some embodiments, other elements or compounds can be added to compensate or modify the chemistry of the powder. In some embodiments, the powder can be de-dusted to remove fines.

In some embodiments, the previously used powder can be modified to make it more applicable as the feedstock as the previous processing can make the powder/particles unusable. In some embodiments, “satellites,” which can hurt/reduce flow can be removed. Further, used powder can become agglomerated, and the disclosed process can separate the particles in the powder. In some embodiments, contaminants, such as organics, can be removed. In some embodiments, carbon, nitrogen, oxygen, and hydrogen can be removed from the previously used powder by the disclosed process. In some embodiments, artifacts can be removed. The disclosed process can also improve the flowability of the used powders. In some embodiments, surface texture can be adjusted to reduce surface roughness of used powder to improve flowability. In some embodiments, flowability can be improved by absorbing satellites. In some embodiments, residence time and power levels of a microwave plasma can be modified to absorb satellites or evaporate them, such as with minimal affect the chemistry of the bulk Cu-alloy powders.

Generally, embodiments of the disclosed methods can re-spheroidize the used Cu-alloy powers, for example a powder having particles that were spherical and have lost sphericity during a previous process, such as AM. These previous processes can include, but are not limited to, to laser powder bed fusion (L-PBF), electron-beam powder bed fusion (EB-PBF), directed energy deposition (DED), and binder jetting. In some embodiments, the used powder can be larger powder waste from an electron beam process, which can then be made into a smaller powder for laser application. In some embodiments, after use, the powder has agglomerations, increased oxygen content, contamination from soot and inorganic materials, and/or deformation which makes them non-spherical. In these embodiments, the Cu-alloy powders cannot be reused without processing.

In some embodiments, particle size distribution (PSD) of used powder particles and of recycled/rejuvenated particles comprises a minimum diameter (i.e., D10) of 12 micrometers (μm) and a maximum diameter (i.e., D90) of 42 μm, or a minimum of 5 μm and a maximum of 15 μm, or a minimum of 5 μm and a maximum of 23 μm, or a maximum of 23 μm, or a minimum of 15 μm and a maximum of 45 μm or a minimum of 22 μm and a maximum of 45 μm, or a minimum of 20 μm to a maximum of 63 μm, or a minimum of 45 μm and a maximum of 70 μm, or a minimum of 70 μm and a maximum of 106 μm, or a minimum of 105 μm to a maximum of 150 μm, or a minimum of 106 μm and a maximum of 300 μm, or other standard sizes per AMS7025 such as 0-23, or 0-45, or 5-45, or 10-45, or 15-45, or 20-45, or 0-53, or 5-53, or 10-53, or 15-53, or 20-53, or 20-90, or 45-106, or 45-125, or 45-150. As will be appreciated, these upper and lower values are provided for illustrative purposes only, and alternative PSD values may be used in other embodiments. In some embodiments, the disclosed processing methods retains alloy elements especially highly volatile elements such as Al, Cr, and Cu from the used powder.

This disclosure describes the rejuvenation of used Cu-alloy powders described above to produce recycled/rejuvenated powders with improved specifications sufficient for AM processing. In some embodiments, a microwave plasma process comprising exposing used Cu-alloy powders to microwave generated plasma is used to rejuvenate used powders described above to better specifications, such that they can be used again as feedstock to the AM, near net shape (NNS) HIP, or HIP+extrusion processes described above.

In some embodiments, through the processing of used Cu-alloy powders, the particle size distribution can be maintained. In some embodiments, the particle size distribution can be improved/tightened by absorbing satellites. In some embodiments, the particle size distribution can be improved/tightened by re-spheroidizing large agglomerates. For example, for laser powder bed with 15-45 μm particle size distribution, used powder can include a) 5% by weight of satellites that are absorbed or evaporated by the microwave plasma process, and b) large misshapen agglomerations, both of which can be removed by embodiments of the disclosed process. In some embodiments, the particle size distribution can be the D50 of the particles in the powder.

In some embodiments, the plasma gases can be specific to the materials of the powders. As an example, in the case of Cu-alloys, and GrCop42 in particular, a reducing gas, such as H₂, may be used as a plasma gas to remove oxygen from the Cu-alloy particle. In a H₂ plasma environment with an inert gas, such as argon, the processed powder may not be chemically altered, besides the removal of oxygen. Also, using a noble gas with hydrogen gas may increase the uniformity of the plasma. In some instances, noble gases and mixtures such as argon a and argon/hydrogen mixtures are used to avoid any additional reaction between the powders and the plasma gases.

The recycling/rejuvenation of the used powder/particles can include the removal of artifacts, such as from an AM process. Further, satellites and agglomerated materials due to overheating, for example from a laser process outside a build line, can be removed. The particular process to form the used particles, such as additive processes, powder bed fusion, and binder jetting, is not limiting and other processes could have been performed on the original particles.

The recycling/rejuvenation of the used powder/particles can allow the powder/particles to, in some embodiments, regain their original rheological properties (such as bulk density, flowability, etc.). In fact, in some embodiments, the recycling/rejuvenation of used powder/particles can also improve the rheological properties. This can be achieved through the removing of any satellite on the surface through surface melting of the satellites and their incorporation into the bulk of the particle. In some cases, partial melting of the particles may densify particles and remove porosity. Also, in some embodiments, spheroidizing the powders increases their flowability.

A satellite may comprise a main powder particle that has a size that is within the defined particle size distribution to which a small particle of much smaller diameter that is outside the particle size distribution than the diameter of the main particle is agglomerated either through sintering or other physical processes. An agglomeration can be two or more particles which coalesce to form a larger particle.

Further, the recycling/rejuvenation can minimize oxygen content in the recycled powder. This can be achieved by, for example, adding hydrogen or another reducing agent, running in a closed environment, or running at a high temperature. In some embodiments, atmospheric pressure inert gas can be used. In some embodiments, a low oxygen environment can be used. In some embodiments, the alloying component chemistry or minor component chemistry may not be altered. In some embodiments, certain elements with low melting temperatures may be removed from the powder.

### Plasma Processing

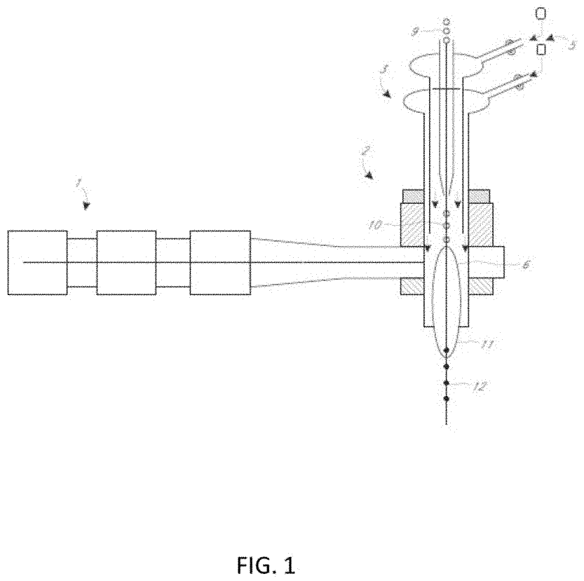

FIG. 1 illustrates an exemplary microwave plasma torch that can be used in the production of Cu-alloy materials, according to embodiments of the present disclosure. Feed materials 9, 10 comprising used Cu-alloy particles can be introduced into a microwave plasma torch 2 in an introduction zone 3, the torch sustaining a microwave-generated plasma 11. In one example embodiment, an entrainment gas flow, and a sheath flow (downward arrows) may be injected through inlets 5 to create flow conditions within the plasma torch 2 prior to ignition of the plasma 11 via microwave radiation source 1.

In some embodiments, the entrainment flow and sheath flow are both axis-symmetric and laminar, while in other embodiments the gas flows are swirling. The feed materials 9 are introduced axially into the microwave plasma torch 2, where they are entrained by a gas flow that directs the materials toward the plasma hot zone 6. As discussed above, the gas flows can consist of a noble gas column of the periodic table, such as helium, neon, argon, etc. Within the microwave-generated plasma, the feed materials are melted in order to spheroidize the materials. Inlets 5 can be used to introduce process gases to entrain and accelerate particles 9, 10 along axis 12 towards plasma 11. First, particles 9 are accelerated by entrainment using a core laminar gas flow (upper set of arrows) created through an annular gap within the plasma torch. A second laminar flow (lower set of arrows) can be created through a second annular gap to provide laminar sheathing for the inside wall of dielectric torch to protect it from melting due to heat radiation from plasma 11. In exemplary embodiments, the laminar flows direct particles 9, 10 toward the plasma 11 along a path as close as possible to axis 12, exposing them to a substantially uniform temperature within the plasma.

In some embodiments, suitable flow conditions are present to keep particles 10 from reaching the inner wall of the plasma torch 2 where plasma attachment could take place. Particles 9, 10 are guided by the gas flows towards microwave plasma 11 were each undergoes homogeneous thermal treatment. Various parameters of the microwave-generated plasma, as well as particle parameters, may be adjusted in order to achieve desired results. These parameters may include microwave power, feed material size, feed material insertion rate, gas flow rates, plasma temperature, residence time and cooling rates. In some embodiments, the cooling or quenching rate is not less than 10⁺³ degrees C./sec upon exiting plasma 11. As discussed above, in this particular embodiment, the gas flows are laminar; however, in alternative embodiments, swirl flows or turbulent flows may be used to direct the feed materials toward the plasma.

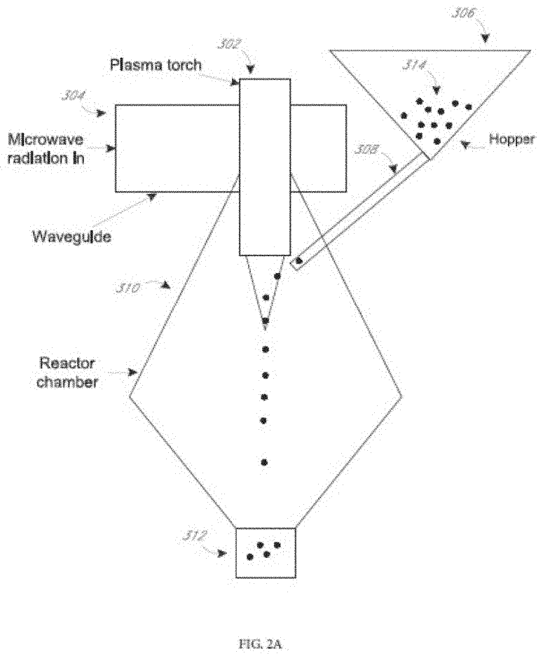

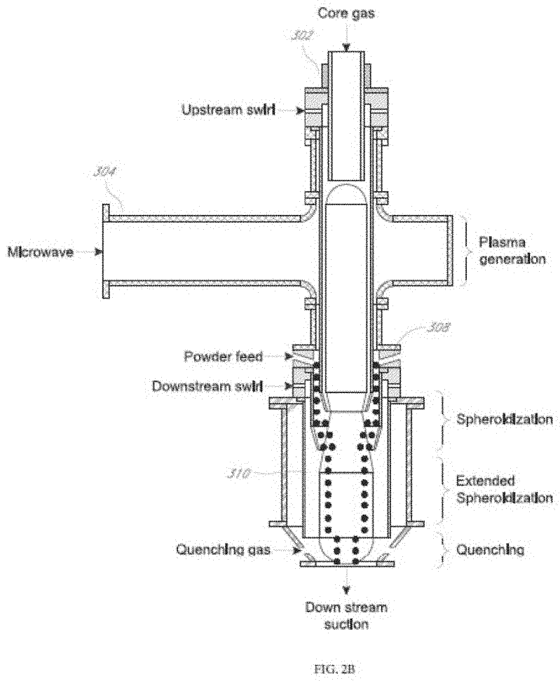

FIGS. 2A-B illustrates an exemplary microwave plasma torch that includes a side feeding hopper rather than the top feeding hopper shown in the embodiment of FIG. 1, thus allowing for downstream feeding. Thus, in this implementation the feedstock is injected after the microwave plasma torch applicator for processing in the “plume” or “exhaust” of the microwave plasma torch. Thus, the plasma of the microwave plasma torch is engaged at the exit end of the plasma torch to allow downstream feeding of the feedstock, as opposed to the top-feeding (or upstream feeding) discussed with respect to FIG. 1. This downstream feeding can advantageously extend the lifetime of the torch as the hot zone is preserved indefinitely from any material deposits on the walls of the hot zone liner. Furthermore, it allows engaging the plasma plume downstream at temperature suitable for optimal melting of powders through precise targeting of temperature level and residence time. For example, there is the ability to dial the length of the plume using microwave powder, gas flows, and pressure in the quenching vessel that contains the plasma plume.

Generally, the downstream spheroidization method can utilize two main hardware configurations to establish a stable plasma plume which are: annular torch, such as described in U.S. Pat. Pub. No. 2018/0297122, or swirl torches described in U.S. Pat. Nos. 8,748,785 B2 and 9,932,673 B2. A feed system close-coupled with the plasma plume at the exit of the plasma torch is used to feed powder axis-symmetrically to preserve process homogeneity.

Other feeding configurations may include one or several individual feeding nozzles surrounding the plasma plume. The feedstock powder can enter the plasma at a point from any direction and can be fed in from any direction, 360° around the plasma, into the point within the plasma. The feedstock powder can enter the plasma at a specific position along the length of the plasma plume where a specific temperature has been measured and a residence time estimated for sufficient melting of the particles.

The feed materials 314 can be introduced into a microwave plasma torch 302. A hopper 306 can be used to store the feed material 314 before feeding the feed material 314 into the microwave plasma torch 302, plume, or exhaust. The feed material 314 can be injected at any angle to the longitudinal direction of the plasma torch 302. 5, 10, 15, 20, 25, 30, 35, 40, 45, 50, or 55 degrees. In some embodiments, the feedstock can be injected an angle of greater than 5, 10, 15, 20, 25, 30, 35, 40, 45, 50, or 55 degrees. In some embodiments, the feedstock can be injected an angle of less than 5, 10, 15, 20, 25, 30, 35, 40, 45, 50, or 55 degrees. In alternative embodiments, the feedstock can be injected along the longitudinal axis of the plasma torch.

The microwave radiation can be brought into the plasma torch through a waveguide 304. The feed material 314 is fed into a plasma chamber 310 and is placed into contact with the plasma generated by the plasma torch 302. When in contact with the plasma, plasma plume, or plasma exhaust, the feed material melts. While still in the plasma chamber 310, the feed material 314 cools and solidifies before being collected into a container 312. Alternatively, the feed material 314 can exit the plasma chamber 310 while still in a melted phase to cool and solidify outside the plasma chamber. In some embodiments, a quenching chamber may be used, which may or may not use positive pressure. While described separately from FIG. 1, the embodiments of FIGS. 2A and 2B are understood to use similar features and conditions to the embodiment of FIG. 1.

### Spheroidization

In some embodiments, the recycled powders particles achieved by the plasma processing can be spherical or spheroidal, terms that can be used interchangeably. Embodiments of the present disclosure are directed to producing particles that are substantially spherical or spheroidal or have undergone significant spheroidization. In some embodiments, spherical, spheroidal or spheroidized particles refer to particles having a sphericity greater than a certain threshold. Particle sphericity can be calculated by calculating the surface area of a sphere with a volume matching that of the particle, V using the following equation:

$${r}_{ideal} = \sqrt[2]{\frac{3 V}{4 π}}$$

$${A}_{s , ideal} = 4 π {r}_{ideal}^{2}$$

and then comparing that idealized surface area with the measured surface area of the particle:

$$sphericity = \frac{{A}_{s , ideal}}{{A}_{s , actual}} .$$

In some embodiments, particles can have a sphericity (also referred to herein as sphericity factor) of greater than 0.5, 0.6, 0.7, 0.75, 0.8, 0.9, 0.91, 0.95, or 0.99 (or greater than about 0.5, about 0.6, about 0.7, about 0.75, about 0.8, about 0.8, about 0.91, about 0.95, or about 0.99). In some embodiments, particles can have a sphericity of 0.75 or greater or 0.91 or greater (or about 0.75 or greater or about 0.91 or greater). In some embodiments, particles can have a sphericity of less than 0.5, 0.6, 0.7, 0.75, 0.8, 0.9, 0.91, 0.95, or 0.99 (or less than about 0.5, about 0.6, about 0.7, about 0.75, about 0.8, about 0.8, about 0.91, about 0.95, or about 0.99). In some embodiments, a particle is considered to be spherical, spheroidal or spheroidized if it has a sphericity at or above any of the aforementioned sphericity values, and in some preferred embodiments, a particle is considered to be spherical if its sphericity is at or about 0.75 or greater or at or about 0.91 or greater.

In some embodiments, a median sphericity of all particles within a given powder can be greater than 0.5, 0.6, 0.7, 0.75, 0.8, 0.9, 0.91, 0.95, or 0.99 (or greater than about 0.5, about 0.6, about 0.7, about 0.75, about 0.8, about 0.8, about 0.91, about 0.95, or about 0.99). In some embodiments, a median sphericity of all particles within a given powder can be less than 0.5, 0.6, 0.7, 0.75, 0.8, 0.9, 0.91, 0.95, or 0.99 (or less than about 0.5, about 0.6, about 0.7, about 0.75, about 0.8, about 0.8, about 0.91, about 0.95, or about 0.99). In some embodiments, a powder is considered to be spheroidized if all or a threshold percentage (as described by any of the fractions below) of the particles measured for the given powder have a median sphericity greater than or equal to any of the aforementioned sphericity values, and in some preferred embodiments, a powder is considered to be spheroidized if all or a threshold percentage of the particles have a median sphericity at or about 0.75 or greater or at or about 0.91 or greater.

In some embodiments, the fraction of particles within a powder that can be above a given sphericity threshold, such as described above, can be greater than 50%, 60%, 70%, 80%, 90%, 95%, or 99% (or greater than about 50%, about 60%, about 70%, about 80%, about 90%, about 95%, or about 99%). In some embodiments, the fraction of particles within a powder that can be above a given sphericity threshold, such as described above, can be less than 50%, 60%, 70%, 80%, 90%, 95%, or 99% (or less than about 50%, about 60%, about 70%, about 80%, about 90%, about 95%, or about 99%).

Particle size distribution and sphericity may be determined by any suitable known technique such as by SEM, optical microscopy, dynamic light scattering, laser diffraction, manual measurement of dimensions using an image analysis software, for example from about 15-30 measures per image over at least three images of the same material section or sample, and any other techniques.

### Examples

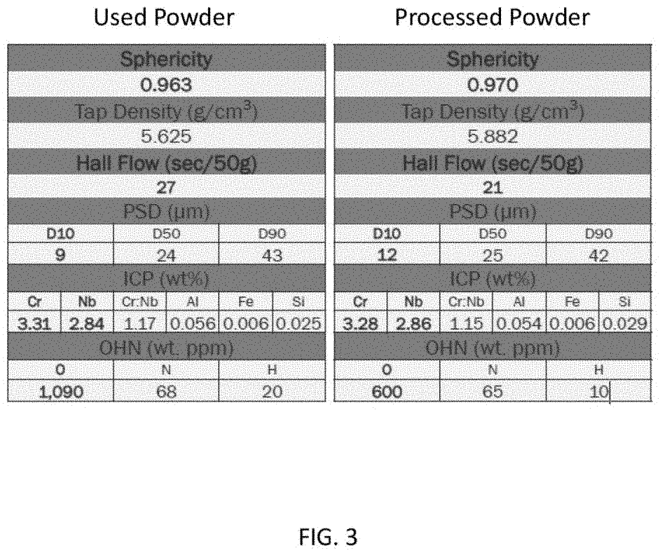

FIG. 3 illustrates a table comparing properties of an example used powder and a recycled Cu-alloy powder processed according to some embodiments described herein. As shown in the FIG. 3, microwave plasma processing of the used powder in H₂ plasma gas and argon resulted in improved sphericity, tap density and flowability in the recycled Cu-alloy powder. In the illustrated example, the PSD was not significantly changed between the example used powder and the recycled Cu-alloy powder, although the PSD may optionally be altered during the plasma processing or using pre- or post-processing. In addition, the composition of the powder was not significantly changed in the final recycled Cu-alloy powder. However, the oxygen wt. ppm was significantly reduced in the recycled Cu-alloy powder (600 wt. ppm) relative to the used powder (1,090 wt. ppm).

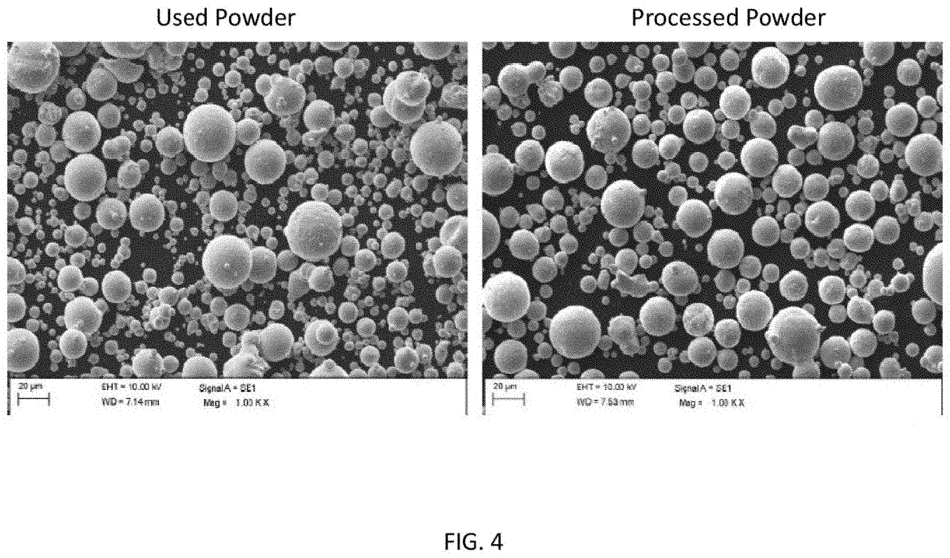

FIG. 4 illustrates a microscopic image comparing example used particles and a recycled Cu-alloy powder processed according to some embodiments described herein. As illustrated, the microwave-plasma processed recycled Cu-alloy powder exhibits improved sphericity, with a visible reduction in agglomerations/satellites relative to the used powder. Furthermore, there is a reduction in surface oxide in the recycled Cu-alloy powder as a result of the plasma processing. In some embodiments, the plasma processing avoids a full re-melting of the used powder, avoiding coarsening and heterogeneity of the microstructure. As shown in FIG. 4, the microstructure of the Cu-alloy powder is substantially homogenous.

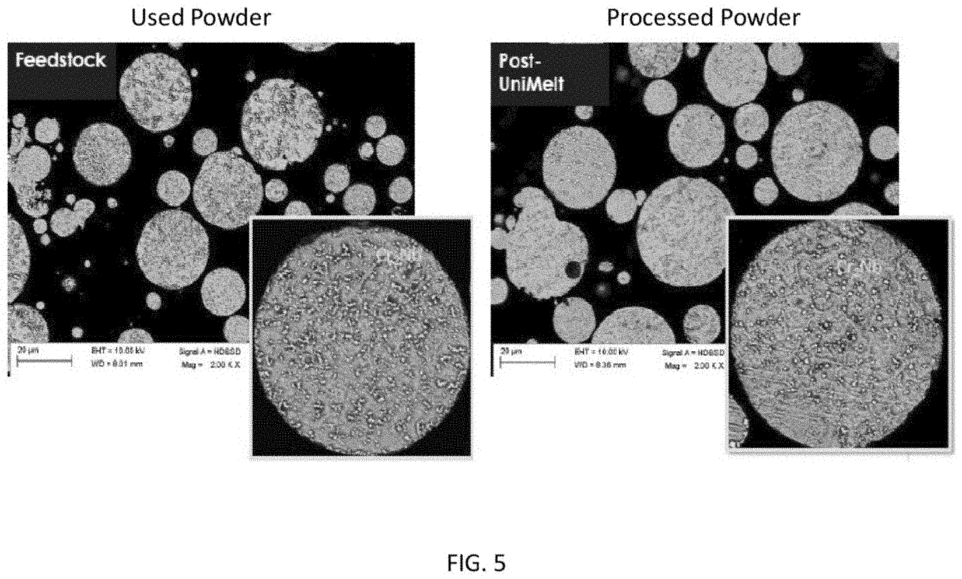

FIG. 5 illustrates cross-sectional back-scattered electron detector (BSE) images comparing example used particles and a recycled Cu-alloy powder processed according to some embodiments described herein. The samples were polished and etched with FeCl₃ solution to reveal intermetallic structure. As illustrated in FIG. 5, comparable intermetallic size/spacing can be seen in both the used powder and the recycled Cu-alloy powder.

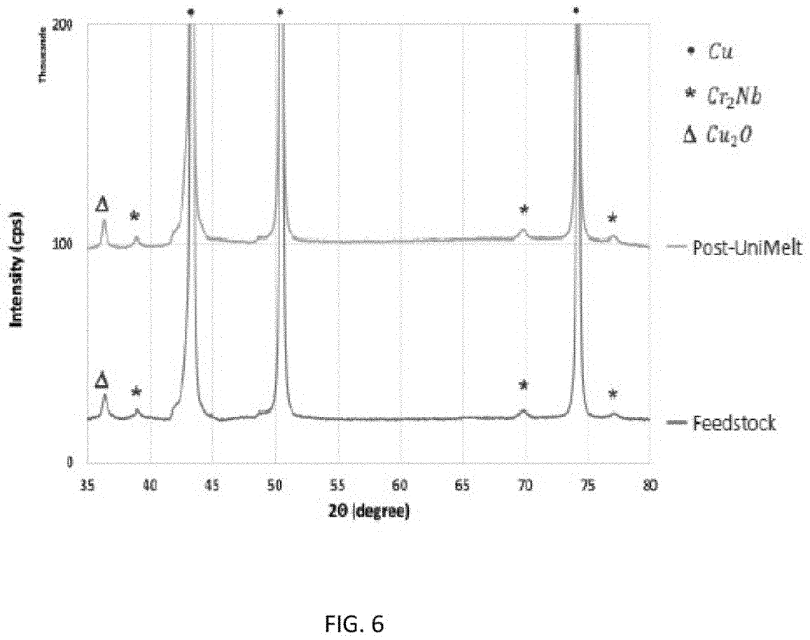

FIG. 6 illustrates an example x-ray powder diffraction (XRD) plot comparing example used particles and a recycled Cu-alloy powder processed according to some embodiments described herein. As illustrated, XRD analysis did not detect any significant phase changes in the processed powder, indicating no significant microstructural changes. Furthermore, both XRD spectra show Cu reflections and low-intensity reflection for Cr₂Nb intermetallic.

As shown in the above examples, the microwave plasma processing embodiments herein are capable of recycling used Cu-alloy powder to produce a recycled powder having improved sphericity, while maintaining the bulk chemistry and intermetallic size/spacing, while reducing oxygen content to at or below about 600 wt. ppm.

### Additional Embodiments

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense.

Indeed, although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Any methods disclosed herein need not be performed in the order recited. Thus, it is intended that the scope of the invention herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is

It will also be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein.

What is claimed is:

1. A method for manufacturing recycled copper alloy powder particles from used copper alloy powder particles, the method comprising:
introducing used or deficient copper alloy powder particles into a microwave plasma torch, the used or deficient copper alloy powder particles comprising an oxygen content above 600 ppm by weight; and
heating the used or deficient copper alloy powder particles within the microwave plasma torch to form recycled copper alloy powder particles, the recycled copper alloy powder particles comprising a reduced oxygen content relative to the used or deficient copper alloy.

2. The method of claim 1 wherein the recycled copper alloy powder has an oxygen content at or below 600 ppm by weight.

3. The method of claim 1, wherein the used or deficient copper alloy powder particles and the recycled copper alloy powder particles comprise a GRCop (Cu—Cr₂Nb) family alloy.

4. The method of claim 3, wherein the GRCop family alloy comprises GRCop-42.

5. The method of claim 1, further comprising collecting the used or deficient copper alloy powder particles from an additive manufacturing process.

6. The method of claim 1, wherein the used or deficient powder particles comprise an oxygen content above 1000 ppm by weight.

7. The method of claim 1, wherein the recycled copper alloy powder particles comprise an oxygen content at or below 500 ppm by weight.

8. The method of claim 1, wherein the used or deficient copper alloy powder particles are heated to a temperature sufficient to remove oxygen from a surface and/or sub-surface of the used or deficient copper alloy powder particles.

9. The method of claim 1, wherein the used or deficient copper alloy powder particles are heated to a temperature of less than 1,100° C.

10. The method of claim 1, wherein a reducing gas is introduced into the microwave plasma torch to generate a microwave plasma that heats the used or deficient copper alloy powder particles within the microwave plasma torch.

11. The method of claim 10, wherein the reducing gas is hydrogen gas (H₂).

12. The method of claim 11, wherein the hydrogen gas is mixed with argon gas.

13. The method of claim 11, wherein the hydrogen gas reacts with the used or deficient powder particles to reduce the oxygen content.

14. The method of claim 1, wherein the recycled copper alloy powder particles have a median sphericity of at least 0.950.

15. The method of claim 1, wherein the recycled copper alloy powder particles have a D50 of about 15 μm to about 45 μm.

16. Recycled copper alloy particles manufactured by a process comprising:
introducing used or deficient copper alloy powder particles into a microwave plasma torch, the used or deficient copper alloy powder particles comprising an oxygen content above 600 ppm by weight; and
heating the used or deficient copper alloy powder particles within the microwave plasma torch to form recycled copper alloy powder particles, the recycled copper alloy powder particles comprising a reduced oxygen content relative to the used or deficient copper alloy.

17. The method of claim 16, wherein the recycled copper alloy powder has an oxygen content at or below 600 ppm by weight.

18. The recycled copper alloy particles of claim 16, wherein the recycled copper alloy powder particles have a median sphericity of at least 0.950.

19. The recycled copper alloy particles of claim 16, wherein the recycled copper alloy powder particles have a D50 of about 15 μm to about 45 μm.

20. The recycled copper alloy particles of claim 16, wherein the used or deficient copper alloy powder particles and the recycled copper alloy powder particles comprise a GRCop family alloy, wherein the GRCop (Cu—Cr₂Nb) family alloy comprises GRCop-42.
